(19) United States
(12) Patent Application Publication
(10) Pub. No.: US 2016/0167180 A1
(43) Pub. Date: Jun. 16, 2016

(54) DIRECT DEPOSITION OF METALLIC COATING

(71) Applicant: United Technologies Corporation, Hartford, CT (US)

(72) Inventors: Henry H. Thayer, Wethersfield, CT (US); Giovanni Whitman, Middletown, CT (US); Gary J. Larson, Madison, CT (US); Wangen Lin, S. Glastonbury, CT (US)

(73) Assignee: United Technologies Corporation, Hartford, CT (US)

(21) Appl. No.: 14/965,050

(22) Filed: Dec. 10, 2015

Related U.S. Application Data
(60) Provisional application No. 62/091,901, filed on Dec. 15, 2014.

(51) Int. Cl. B23P 6/00; C23C 28/02; B22F 1/02; C23C 24/10

(52) U.S. Cl. CPC B23P 6/007; C23C 24/106; C23C 28/02; B22F 1/025

(57) ABSTRACT

A method for coating a part according to an aspect of the disclosure includes the step binding a metallic powder to a section of the part. The metallic powder is then energized which at least partially melts and resolidifies the metallic powder to form a first metallic coating. After the first layer of metallic coating is formed a second layer of metallic coating is deposited on substantially all of the part.

### CROSS-REFERENCE TO RELATED APPLICATION(S)

This application claims the benefit of U.S. Provisional Application No. 62/091,901, filed Dec. 15, 2014 for “DIRECT DEPOSITION OF METALLIC COATING” the disclosure of which is incorporated by reference in its entirety.

### BACKGROUND

This disclosure relates to methods of coating a part and more specifically to uniformly coating a part that includes a non-line-of-sight (NLOS) portion.

Coatings are used to protect surfaces of parts such as those used in a gas turbine engine. In a gas turbine, engine parts such as turbine vanes are routinely exposed to high temperatures as a result of hot combustion gases that pass over the vanes. Exposure to these gases, over time, can decrease the lifespan of the vane, which can lead to increased costs due to maintenance or failure of the vane.

Coating turbine blades that are provided in a cluster can be challenging This is because portions of the vanes in a cluster shadow each other which creates an NLOS section on at least one of the vanes. It is difficult to apply a uniform coating to a vane cluster using spray coating, for example, because the NLOS section is not accessible to the spray coating. Therefore, using conventional techniques, each vane in the vane cluster will not have a uniform coating. There is thus a need for improved coating techniques for vane assemblies containing shadowed vane sections.

### SUMMARY

A method for coating a part according to an aspect of the disclosure includes the step binding a metallic powder to a section of the part. The metallic powder is then energized which at least partially melts and resolidifies the metallic powder to form a first metallic coating. After the first layer of metallic coating is formed, a second layer of metallic coating is deposited on substantially all of the part.

In a further aspect of the disclosure a method for uniformly coating a vane includes the step of binding a metallic powder to an inboard surface of the vane that is shadowed by another vane of a vane cluster. The metallic powder is then energized which at least partially melts and resolidifies the metallic powder to form a first metallic coating having a desired thickness on the shadowed inboard surface of the vane. After the first layer of metallic coating is formed, a second metallic coating is deposited on substantially the entire vane. The first and second coatings are deposited to provide a substantially uniform coating on the vane.

### BRIEF DESCRIPTION OF THE DRAWINGS

FIG. 1 is a flow diagram showing an embodiment of a method of coating a part.

FIG. 2 is a partial cross-sectional view of a gas turbine engine.

FIG. 3 is a perspective view of a vane cluster.

FIG. 4 is a cross-sectional view of an uncoated vane cluster showing a non-line of sight area.

FIG.5 is a cross-sectional view of a vane cluster showing an electro-spark-deposition applicator.

FIG. 6 is a cross-sectional view of a coated vane cluster.

### DETAILED DESCRIPTION

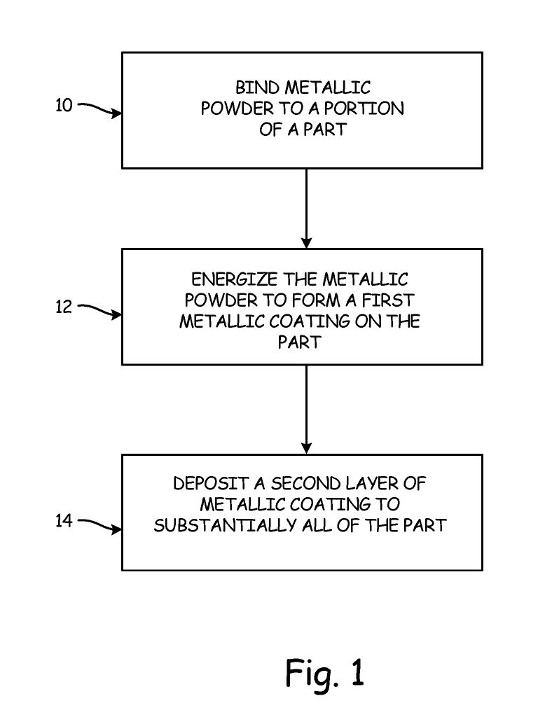

Disclosed herein is a method for providing a uniform metallic coating to a part that includes a non-line-of-sight (NLOS) section. One embodiment of the method includes depositing a first metallic coating to a section of the part. As shown in FIG. 1, depositing the first metallic coating includes binding step 10 which includes binding a metallic powder to the section of the part. Energizing step 12 follows binding step 10 and includes using a contact-metal deposition process to energize and at least partially melt the powder. Upon resolidification of the powder, a first metallic coating is formed. After the first metallic coating is formed, a second metallic coating is deposited on substantially all of the part at deposition step 14. As further discussed below, coating a part according to this method has many benefits, including the following non-limiting examples: increasing the overall speed of the coating process; exposing the part being coated to minimal heat and force; and providing a substantially uniform metallic coating on the part.

To better illustrate the principles of this disclosure, another embodiment will be described. In this embodiment, the part to be coated is a turbine vane cluster of a gas turbine engine. One having ordinary skill in the art will understand, however, that the principles described herein are applicable to coating many parts and are not limited to turbine vane clusters.

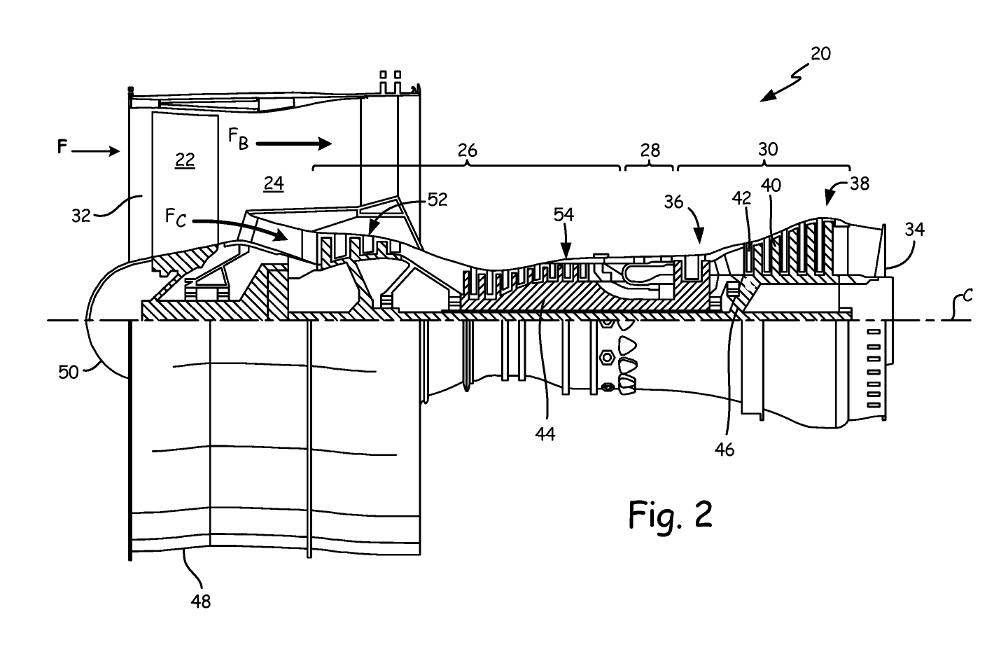

To understand the need to coat turbine vane clusters and the considerations involved, the general operating principles of an exemplary gas turbine engine in accordance with the embodiments of the present disclosure will be described with respect to FIG. 2. FIG. 2 is a cross-sectional view of gas turbine engine 20. Gas turbine engine 20 includes fan 22 with bypass duct 24 oriented about a turbine core having compressor section 26, combustor(s) 28, and turbine 30, which are arranged in flow series along an axial direction with an upstream inlet 32 and downstream exhaust 34.

Turbine 30 includes high-pressure (HPT) section 36 and low-pressure (LPT) section 38. Turbine sections 36 and 38 each have a number of alternating turbine blades 40 and turbine vanes 42. Turbine vanes 42 are circumferentially oriented with respect to one another, and collectively form a full, annular ring about turbine centerline axis C_{L} of gas turbine engine 20. HPT section 36 of turbine 30 is coupled to compressor section 26 via HPT shaft 44, forming the high pressure spool. Low-pressure section 38 is coupled to fan 22 via LPT shaft 46, forming the low pressure spool. LPT shaft 46 is coaxially mounted within HPT shaft 44, about turbine centerline axis C_{L}.

Fan 22 is typically mounted to a fan disk or other rotating member, which is driven by LPT shaft 46. As shown in FIG. 2, for example, fan 22 is forward-mounted in engine cowling 48, upstream of bypass duct 24 and compressor section 26, with spinner 50 covering the fan disk to improve aerodynamic performance. Alternatively, fan 22 is aft-mounted in a downstream location, and the coupling configuration varies. Furthermore, while FIG. 2 illustrates a particular two-spool high-bypass turbofan embodiment of gas turbine engine 20, this example is merely illustrative. In other embodiments, gas turbine engine 20 is configured either as a low-bypass turbofan or a high-bypass turbofan, as described above, and the number of spools and fan position vary.

In operation of gas turbine engine 20, airflow F enters via upstream inlet 32 and divides into bypass flow F_{B} and core flow F_{C} downstream of fan 22. Bypass flow F_{B} passes through bypass duct 24 generating thrust; core flow F_{C} passes along the gas path through compressor section 26, combustor(s) 28 and turbine 30.

Compressor section 26 includes low pressure compressor 52 and high pressure compressor 54 which together compress incoming air for combustor(s) 28 where it is mixed with fuel and ignited to produce hot combustion gas. The combustion gas exits combustor(s) 28 to enter HPT section 36 of turbine 30, driving HPT shaft 44 and thereby compressor section 26. Partially expanded combustion gas transitions from HPT section 36 to LPT section 38, driving fan 22 via LPT shaft 46. Exhaust gas exits gas turbine engine 20 via downstream exhaust 34.

The thermodynamic efficiency of gas turbine engine 20 is strongly tied to the overall pressure ratio, as defined between the compressed air pressure entering combustor(s) 28 and the delivery pressure at upstream inlet 32. In general, higher pressure ratios offer increased greater specific thrust, and may result in higher peak gas path temperatures, particularly downstream of combustor(s) 28, including HPT section 36.

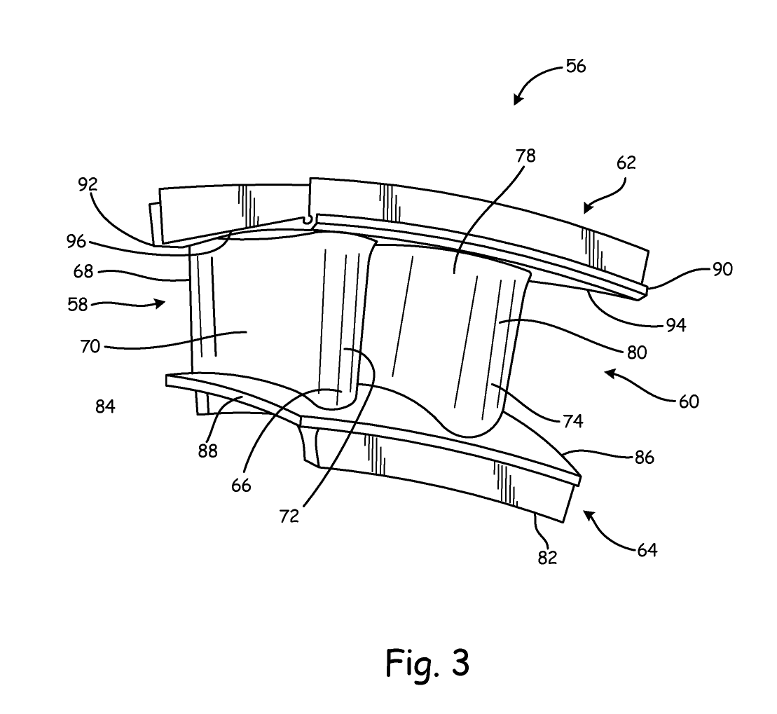

FIG. 3 is a perspective view of vane cluster 56 in HPT 36. In this embodiment vane cluster 56 is a doublet and includes vanes 58 and 60 which are representative of vane 42 as depicted in FIG. 1. In other embodiments, vane cluster 56 may include any plural number of vanes. Vane cluster 56 also includes outer shroud 62, and inner platform 64. Vanes 58 and 60 are secured between outer shroud 62 and inner platform 64. Vane cluster 56 can be formed of any material commonly used in the art such as an aero-space super alloy. For example, suitable non- limiting materials include titanium, titanium alloy, ceramic matrix composite, and monolithic ceramic compositions.

Vane 58 includes leading edge 66, trailing edge 68, pressure sidewall 70, and suction sidewall 72. Pressure sidewall 70 extends between leading edge 66 and trailing edge 68 and forms the concave pressure side of vane 58. Suction sidewall 72 extends between leading edge 66 and trailing edge 68 and forms the convex suction side of vane 58.

Vane 60 is similarly configured. Vane 60 includes leading edge 74, trailing edge 76 (not shown in FIG. 3), pressure sidewall 78, and suction sidewall 80. Pressure sidewall 78 extends between leading edge 74 and trailing edge 76 and forms the concave pressure side of vane 60. Suction sidewall 80 extends between leading edge 74 and trailing edge 76 and forms the convex suction side of vane 60.

Vanes 58 and 60 are circumscribed by inner platform 64 and outer shroud 62. Inner platform 64 is an arcuate band disposed radially outward from C_{L} and is secured to vanes 58 and 60. Inner platform 64 includes leading edge 82, trailing edge 84, suction side edge 86, and pressure side edge 88.

Outer shroud 62 is an arcuate band disposed radially outward from inner platform 64 and is secured to vanes 58 and 60. Outer shroud 62 includes leading edge 90, trailing edge 92, suction side edge 94, and pressure side edge 96. Suction side edge 94 and pressure side edge 96 together with suction side edge 86 and pressure side edge 88 of outer shroud and inner platform, respectively, are secured to outer shrouds and inner platforms (not shown) of adjacent vane clusters to form a complete stationary turbine vane stage circumferentially extending about C_{L}.

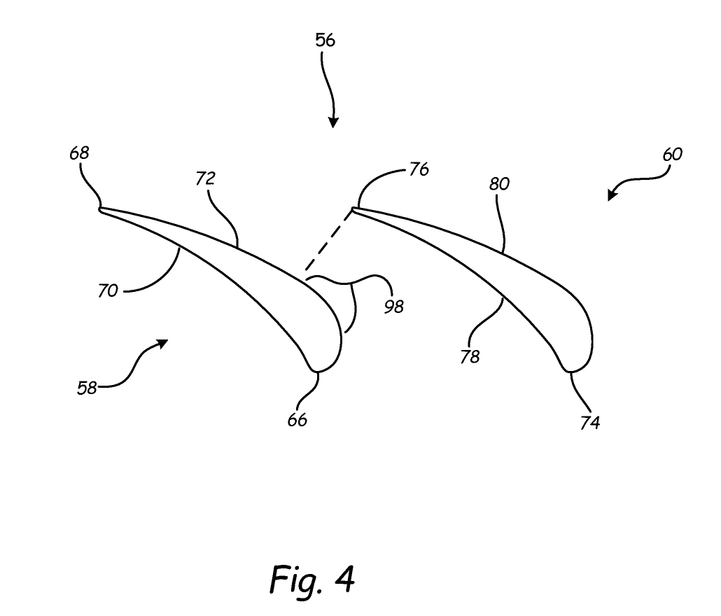

Turbine vanes 58 and 60 direct the flow of hot combustion gases from combustor(s) 28 across turbine blade 40 and through HPT 36. Because turbine vanes 58 and 60 are exposed to extremely high temperatures, it is necessary to coat vanes 58 and 60 with protective metallic coating such as a nickel- or cobalt-based alloy. Coating the vanes can help to increase the performance life of vanes 58 and 60. It is desirable to coat vanes 58 and 60 to have a uniform thickness. In general, uniform coating can help to ensure that one section of either vane 58 or 60 is not damaged before another section. Each vane 58 or 60 can be coated individually before vane cluster 56 is assembled. It can be more efficient, however, to coat vanes 58 and 60 after vane cluster 56 is assembled. Uniformly coating the individual vanes of assembled vane cluster 56 can be difficult, however, because vane cluster 56 includes a first line-of-sight (LOS) section and a second non-line-of-sight (NLOS) section. To explain the difficulties in coating a vane cluster 56 including LOS and NLOS sections reference is made below to FIG. 4 with continuing reference to FIG. 3.

FIG. 4 is a top-plan view of vane cluster 56 showing vanes 58 and 60 but omitting outer shroud 62 and inner platform 64. As described above, with respect to FIG. 3, each of vanes 58 and 60 include a leading edge and a trailing edge with a suction sidewall and pressure sidewall extending therebetween and opposing each other. Metallic coating can generally be deposited to vanes 58 and 60 of vane cluster 56 by one of a few non-limiting techniques, known as LOS techniques, including: low pressure plasma spray; electron beam physical vapor deposition; air spray; or electron beam directed vapor techniques. In some embodiments these LOS coatings are applied by a tool that is able to rotate around vane cluster 56. Alternatively, the tool can be stationary and vane cluster 56 can be rotated as metallic coating is applied.

As illustrated in FIG. 4, suction sidewall 80 of vane 60 and pressure sidewall 70 of vane 58 are outboard surfaces that are directly accessible with many of the above described coating techniques. Pressure sidewall 78 of vane 60 and suction sidewall 72 of vane 58, conversely, are inboard surfaces and include a section where pressure sidewall 78 and suction sidewall 72 partially shadow each other. NLOS section 98 results from the shadowing caused by vane 60 and is located on suction sidewall 72 of vane 58. In other embodiments, depending on the orientation of vanes 58 and 60 with respect to each other, NLOS section 98 can include up to substantially the entire surface of pressure sidewall 78 and suction sidewall 72. Because of the partial shadowing of NLOS section 98 in assembled vane clusters 56, the above described LOS coating techniques are largely prevented from evenly depositing coating on NLOS section 98. For example, a region of NLOS section 98 that is closest to an LOS section may receive some coating but regions farther away from LOS section(s) may receive little or no coating.

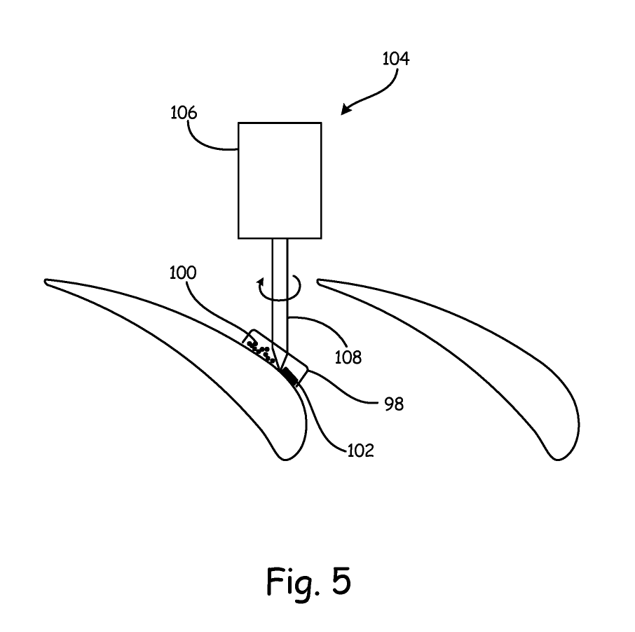

FIG. 5 schematically illustrates an embodiment of a system and method for applying a first metallic coating to NLOS section 98 of vane 58. Many of the same features as described with respect to FIGS. 3 and 4 are shown in FIG. 5 along with the addition of metallic powder 100, first metallic coating 102, and electro-spark-deposition device 104, which includes capacitor-based power supply 106 and electrode 108.

Metallic powder 100 is bound, as will be discussed further below, to NLOS section 98 and can be a nickel- or cobalt-based alloy. In a non-limiting example, the composition of metallic powder 100 can have a composition the includes 20 percent by weight of cobalt, 15 percent by weight of chromium, 11.8 percent by weight of aluminum, 0.4 percent by weight of yttrium, 0.2 percent by weight of silicon, 0.1 percent by weight of hafnium and a remainder of nickel and any trace elements. The size of the particles composing metallic powder 100 can vary. Larger particles may be more difficult to bind to NLOS section 98 while smaller particles may be more difficult to control during the binding process. Particle size selection can depend on the desired properties of first coating 102 or the properties of the binder. As a non-limiting example the average particle diameter of metallic powder 100 can range from about 0.5 micrometers to about 88 micrometers.

Referring back to FIG. 1, at binding step 10 metallic powder 100 is bound to NLOS section 98 of vane 58. To facilitate binding metallic powder 100 to NLOS section 98, a binder can be used. The binder can be a starch-based binder, glucose-based binder, or a protein-based binder. In one embodiment, the protein can be gluten, such as corn gluten, and is suspended or dissolved in a solvent. Acceptable solvents for dissolving binders such as glucose-based binders or proteins are known in the art and can include the following non-limiting examples: methanol; ethanol; ethyl acetate; and water. The binder and solvent solution's concentration can vary depending on the solubility of the binder or desired properties of the solution. For example, the solution could be 20-80 percent by volume binder with the balance being solvent or 40-60 percent by volume binder with the balance being solvent.

The binder and metallic powder 100 can be deposited on NLOS section 98 several ways. For example, the binder and metallic powder 100 can be sprayed or painted on NLOS section 98. The binder and metallic powder 100 can, additionally, be deposited on NLOS section 98 individually or together (e.g., in a slurry).

As an example of binding step 10, binder can be first applied to the NLOS section 98 (e.g., by painting). After the binder is applied, metallic powder 100 can be sprayed, within a stream of inert gas such as argon, onto the binder. To accomplish this, metallic powder 100 and the argon gas can dispensed through a tube to deposit on NLOS section 98. The tube can be small and flexible and can, therefore, be positioned within an area that is difficult to access such as the NLOS section 98 of vane 58.

After metallic powder 100 is bound on NLOS section 98, first metallic coating 102 is formed by the application of an electro-spark deposition process to metallic powder 100 in accordance with energizing step 12, referenced in FIG. 1. Electro-spark deposition is a type of contact-metal deposition process. Electro-spark deposition may, alternatively, be known as spark hardening, electro-spark toughening, electro-spark alloying, pulsed fusion surfacing, or pulsed electrode surfacing. Electro-spark deposition device 104 is used to perform the process and can include capacitor-based power supply 106 and electrode 108. In certain embodiments electrode 108 is formed from the same alloy as metallic powder 100 (e.g., Ni- or Co-based alloy). In further embodiments electrode 108 can be configured to rotate during deposition. Rotation of electrode 108 can help to evenly distribute molten electrode material to NLOS section 98.

In operation of electro-spark-deposition device 104, electrode 108 is in contact with NLOS section 98, a first voltage is then applied to electrode 108, and a second voltage is then applied to vane cluster 56. The first voltage is greater than the second voltage and the second voltage is a ground. The first voltage generates a plasma arc at a high temperature between the tip of electrode 108 and NLOS section 98. In some embodiments the temperature can range from about 8,000° C. to about 25,000° C. The plasma arc ionizes electrode 108 and a small amount of molten electrode material is transferred from electrode 108 to NLOS section 98. The plasma arc also melts metallic powder 100 already present on NLOS section 98. Both of the molten electrode material and molten metallic powder 100 resolidfy to form first metallic coating 102 on NLOS section 98. First metallic coating 102 thus is composed of metallic powder 100 that is bound to NLOS section 98 along with molten metal from electrode 108.

There are many benefits in using electro-spark deposition to form first metallic coating 102 including the following non-limiting examples. First, the electro-spark deposition process is able to melt a portion of electrode 108 and metallic powder 100 while imparting minimal heat input to vane 58. This is because the current pulses generating heat are short duration pulses. Second, the force applied to vane 58 by electrode 108 is minimal (e.g., about 3N to about 5N). Therefore, because of the low heat input and low amount of force applied to vane 58, vane 58's microstructure is substantially unaltered through the deposition process. This is in contrast to other deposition techniques such as laser and resistance welding, which may alter the microstructure of the substrate being coated due mostly to high heat imparted to the substrate.

There are many benefits to binding metallic powder 100 to NLOS section 98 prior to using the above described electro-spark deposition process to form first metallic coating 102 including the following non-limiting examples. First, electro-spark deposition, when used alone, can be a slow process. By initially depositing metallic powder 100, however, the overall speed of the process can be increased. This is because molten metal is transferred from electrode 108 as metallic powder 100 is simultaneously melted onto NLOS section 98. Second, first metallic coating 102 can also be thicker than it would be if only electro-spark deposition were used. This is because the maximum thickness of metallic coating that can be formed from molten electrode 108 can be augmented by the melting and resolidification of metallic powder 100.

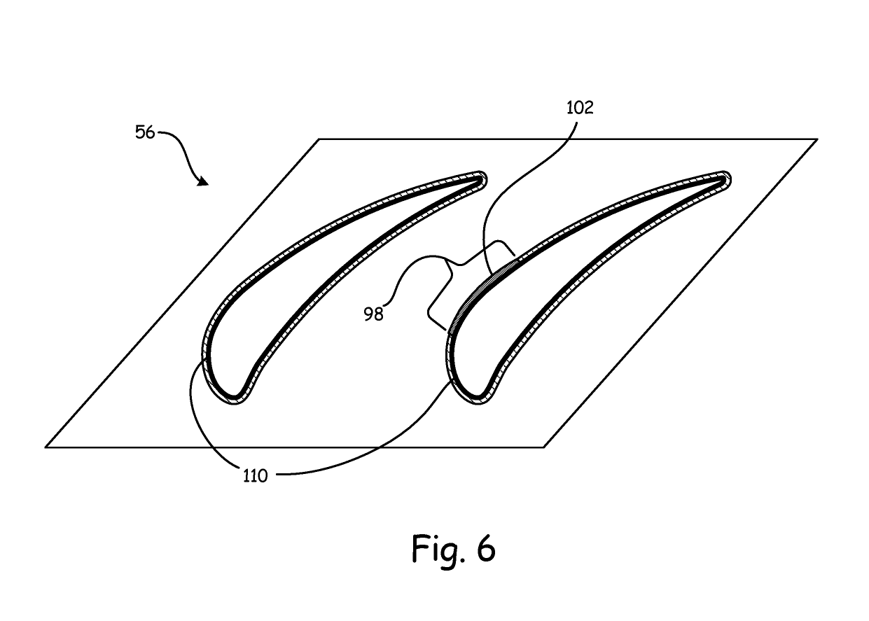

In addition to NLOS section 98 being coated, the remainder of vane cluster 56 is also coated. FIG. 6 shows vane cluster 56 where first metallic coating 102 has been formed in NLOS section 98 in accordance with steps 10 and 12 as described in FIG. 1. As further shown in FIG. 6, second metallic coating 110 has been deposited on substantially all of vane cluster 56 in accordance with step 14, as described in FIG. 1. This includes those sections of vane cluster 56 that are LOS sections. After both metallic coatings 102 and 110 have been applied, vane cluster 56 will have a coating of a uniform thickness.

The deposition techniques for second metallic coating 110 can include: low pressure plasma spray; electron beam physical vapor deposition; air spray; or electron beam directed vapor techniques. As previously described, these techniques are primarily LOS techniques and either provide either no coating to NLOS section 98 or provide a thinner coating than the coating on the LOS sections. The combination of these LOS coating techniques with the coating techniques for NLOS section 98 described above, however, do provide a substantially uniform coating on vane cluster 56.

There are several ways to combine these NLOS and LOS coating techniques. As an example, if second metallic coating 110 is only deposited on the LOS sections of vane cluster 56. The thickness of first metallic coating 102 on NLOS section 98 can, accordingly, be formed to equal the thickness of second metallic coating 110. Thus, a uniform coating of vane cluster 56 can be achieved. FIG. 6 shows an embodiment of coated vane cluster 56 in accordance with this example.

As another example, second metallic coating 110 can be deposited on both the LOS sections and NLOS section 98 of vane cluster 56. Because of the difficulties in coating NLOS section 98 with the above described LOS techniques, second metallic coating 110 will have a first thickness on LOS sections of vane cluster 56 and a second thickness different from the first thickness on NLOS section 98. Usually the second thickness will be less than the first thickness. In this case, a uniform coating of vane cluster 56 can be achieved because the thickness of first metallic coating 102 will augment the second thickness of second metallic coating 110 such that the sum of the thicknesses of first metallic coating 102 and the second thickness of second metallic coating 110 are substantially equivalent to the first thickness of second metallic coating 110.

Discussion of Possible Embodiments

The following are non-exclusive descriptions of possible embodiments of the present invention.

A method of coating a part can include the steps of binding a metallic powder to a section of the part; energizing the metallic powder to at least partially melt and resolidfy the metallic power to form a first metallic coating; and depositing a second metallic coating to substantially all of the part.

The method of the preceding paragraph can optionally include, additionally and/or alternatively, any one or more of the following features, configurations and/or additional components:

A method for coating a part according to an exemplary embodiment of this disclosure, among other possible things may include binding a binder to the part before binding the metallic powder to the part.

A method for coating a part may further include first depositing the binder to the section of the part.

A method for coating a part may include a binder having at least one of a protein, starch, and a sugar suspended or dissolved therein.

A method for coating a part may include a protein that may be used as a binder in which the protein is gluten.

A method for coating a part may include a metallic powder in which the metallic powder may be a nickel- or cobalt-based alloy.

A method for coating a part may include a metallic powder that may be bound to the section of the part by spraying the powder onto the section of the part.

A method for coating a part may include a part that may be a first vane of a vane cluster having a plurality of vanes.

A method for coating a part may include a section of the first vane that is an inboard surface of the first vane that is shadowed by a second vane of the vane cluster.

A method for coating a part may include a second metallic coating that may have a first thickness on a first section of the part and may have a second thickness that may be different from the first thickness the second section of the part.

A method for coating a part may include a contact-metal deposition process which energizes the metallic powder.

A method for coating a part may include a contact-metal deposition process in which the process is an electro-spark deposition process in which the electro-spark deposition process can use an electrode and can include the steps of applying a first voltage to the electrode; applying a second voltage to the part in which the first voltage can be greater than the second voltage; and touching the electrode to the section in which a microstructure of the part is substantially unaltered by the electro-spark deposition process.

A method for coating a part using an electro-spark deposition process can include an electrode that can include a nickel- or cobalt-based alloy which supplies a portion of the metallic coating.

A method for coating a part can include depositing a second metallic coating to substantially all of the part which can be performed by the following techniques: low pressure plasma spray; electron beam physical vapor deposition, air spray, electron beam directed vapor deposition; and combinations thereof.

A method for coating a part can include a metallic powder in which the metallic powder can be energized to form a first metallic coating on the section of the part before the second metallic coating is deposited to substantially all of the part.

In a further embodiment a method of uniformly coating a vane can include the steps of: binding a metallic powder to an inboard surface of a vane that is shadowed by another vane of a vane cluster; the metallic powder can be energized to at least partially melt the metallic powder and resolidify the metallic powder to form a first metallic coating that can have a desired thickness on the shadowed inboard surface of the vane. A second metallic coating can be deposited to substantially the entire vane.

The method of the preceding paragraph can optionally include, additionally and/or alternatively, any one or more of the following features, configurations and/or additional components:

A method for uniformly coating a vane with a shadowed inboard surface can include a second metallic coating that can have a first thickness on a surface of the vane that is not shadowed and can have a second thickness different from the first thickness of the shadowed surface of the vane.

A method for uniformly coating a vane with a shadowed inboard surface can include a second metallic coating in which the first thickness of the second metallic coating can be equal to the sum of the second thickness of the second metallic coating and a third thickness of the first layer of metallic coating.

A method for uniformly coating a vane in which the step of binding the metallic powder can include first depositing a binder to the shadowed inboard surface of the vane followed by depositing the metallic powder on the binder.

A method for uniformly coating a vane can include an electro-spark deposition process to energize the metallic powder and can include the steps of: applying a first voltage to the electrode; applying a second voltage to the vane, in which the first voltage can be greater than the second voltage, and the electrode can touch the shadowed inboard surface of the vane in which a microstructure of the vane can be substantially unaltered by the electro-spark deposition process.

While the disclosure has been described with reference to an exemplary embodiment(s), it will be understood by those skilled in the art that various changes may be made and equivalents may be substituted for elements thereof without departing from the scope of the disclosure. In addition, many modifications may be made to adapt a particular situation or material to the teachings of the disclosure without departing from the essential scope thereof. Therefore, it is intended that the disclosure not be limited to the particular embodiment(s) disclosed, but that it include all embodiments falling within the scope of the appended claims.

1. A method for coating a part, comprising:
binding a metallic powder to a section of the part;
energizing the metallic powder to at least partially melt and resolidify the metallic powder to form a first metallic coating; and
depositing a second metallic coating to substantially all of the part.

2. The method of claim 1, wherein the binding includes applying a binder to the part.

3. The method of claim 2, wherein the binding includes depositing the metallic powder on the binder.

4. The method of claim 2, wherein the binder has at least one of a protein, starch, and a sugar suspended or dissolved therein.

5. The method of claim 4, wherein the protein is gluten.

6. The method of claim 1, wherein the metallic powder comprises a nickel- or cobalt-based alloy.

7. The method of claim 1, wherein the metallic powder is bound to the section of the part by spraying the powder onto the section of the part.

8. The method of claim 1, wherein the part is a first vane of a vane cluster having a plurality of vanes.

9. The method of claim 8, wherein the section of the first vane is an inboard surface of the first vane that is shadowed by a second vane of the vane cluster.

10. The method of claim 1, wherein the second metallic coating has a first thickness on a first section of the part and a second thickness different from the first thickness on a second section of the part.

11. The method of claim 1, wherein a contact metal deposition process energizes the metallic powder.

12. The method of claim 11, wherein the contact metal deposition process is an electro-spark deposition process which utilizes an electrode and comprises:
applying a first voltage to the electrode;
applying a second voltage to the part, wherein the first voltage is greater than the second voltage; and
touching the electrode to the section of the part, wherein a microstructure of the part is substantially unaltered by the electro-spark deposition process.

13. The method of claim 12, wherein the electrode comprises a nickel- or cobalt-based alloy and supplies a portion of the metallic coating.

14. The method of claim 1, wherein the step of depositing the second metallic coating to substantially all of the part is performed using a process selected from a group consisting of: low pressure plasma spray, electron beam physical vapor deposition, air spray, electron beam directed vapor deposition, and combinations thereof.

15. The method of claim 1, wherein the metallic powder is energized to form a first metallic coating on the section of the part before the second metallic coating is deposited to substantially all of the part.

16. A method of coating a vane, comprising:
binding a metallic powder to an inboard surface of the vane that is shadowed by a second vane of a vane cluster;
energizing the metallic powder to at least partially melt and resolidify the metallic powder to form a first metallic coating with a desired thickness on the shadowed inboard surface of the vane; and
depositing a second metallic coating to substantially all of the vane such that the first and second metallic coatings together provide a substantially uniform coating to the vane.

17. The method of claim 16, wherein the second metallic coating has a first thickness on a surface of the vane that is not shadowed and a second thickness different from the first thickness on the shadowed surface of the vane.

18. The method of claim 17, wherein the first thickness of the second metallic coating is equal to the sum of the second thickness of the second metallic coating and a third thickness of the first layer of metallic coating.

19. The method of claim 16, wherein the step of binding the metallic powder includes first depositing a binder to the shadowed surface of the vane followed by depositing the metallic powder on the binder.

20. The method of claim 16, wherein the metallic powder is energized using an electro-spark deposition process and comprises the steps of:
applying a first voltage to an electrode;
applying a second voltage to the vane, wherein the first voltage is greater than the second voltage; and
touching the electrode to the shadowed surface of the vane wherein a microstructure of the vane is substantially unaltered by the electro-spark deposition process.
